(19) United States
(12) Patent Application Publication
(10) Pub. No.: US 2006/0107324 A1
(43) Pub. Date: May 18, 2006

(54) Method to prevent denial of service attack on persistent TCP connections

(75) Inventors: Radhika Chirra, Cedar Park, TX (US); Ranadip Das, Austin, TX (US); Vinit Jain, Austin, TX (US); Venkat Venkatsubra, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/992,514

(22) Filed: Nov. 18, 2004

(51) Int. Cl. G06F 12/14

(52) U.S. Cl. 726/23

(57) ABSTRACT

An improved method, apparatus, and computer instructions for preventing denial of service attacks on persistent connections. A synchronize packet is received. In response to receiving the synchronize packet, a state of the persistent connection is identified. An action on the synchronize packet is deferred until a subsequent communication with a peer to the persistent connection.

### BACKGROUND OF THE INVENTION

1. Technical Field

The present invention relates generally to an improved data processing system and in particular to a method and apparatus for processing data. Still more particularly, the present invention relates to a method, apparatus, and computer instructions for preventing denial of service attacks.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all parts of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach.

With this widespread use, exploitation of computer systems and attacks on Websites have become common place and increasing problematic. These attacks include denial of service attacks. A denial of service attack is an assault on a network that floods it with so many additional requests that regular traffic is either slowed or completely interrupted. Unlike a virus or worm, which can cause severe damage to databases, a denial of service attack interrupts network service for some period of time. A distributed denial of service attack uses multiple computers throughout the network that it has previously infected. The computers act as “zombies” and work together to send out bogus messages, thereby increasing the amount of phony traffic.

An example of one type of denial of service attack on systems involves vulnerabilities in TCP. One example involves persistent TCP connections. An attacker may inject data into or terminate a persistent TCP connection between two endpoints or peers if the sequence number for the receive window is known. An endpoint or peer in an established state is required to abort the connection if the endpoint receives an acceptable TCP segment with a synchronize (SNY) bit set. A segment is a grouping of bytes. A TCP segment is considered acceptable as long as the sequence number for the segment is with in the current window. An attacker, who does not know the sequence number, may reset the connection by guessing at a sequence number that lies within the current window. Window sizes are typically 65536 bytes wide.

An attacker can guess a suitable range of values. The attacker can send out a number of packets with different sequence numbers in the range until one is accepted. The attacker need not send a packet for every sequence number, but can send packets with sequence numbers a window-size apart. If the appropriate range of sequence numbers is covered, one of these packets will be accepted. The total number of packets that needs to be sent is then given by the range to be covered divided by the fraction of the window size that is used as an increment. With the typical window size, the number synchronize packets that need to be sent are 2³²/65536 (with 2³² being the sequence number space), which is 65536 synchronize segments. With a window scale option set to on for the window, the window can be even larger in size, reducing the number of guesses needed. Thus, if an attacker can guess both end's ports, with a DSL connection, this attack would take less than 200 seconds to be successful. In particular, with a typical DSL data connection capable of sending of 250 packets per second to a session with a TCP Window size of 65,535, it would be possible to inject a TCP packet approximately every 5 minutes to an end point. It would take approximately 15 seconds with a T-1 connection.

These numbers are significant when large numbers of compromised machines, such as “botnets” or “zombies”, can be used to generate large amounts of packets that can be directed at a particular host. Although connections may be automatically re-established, a single instance of exploitation would have very little impact on service. A sustained attack, however, could prevent the service from being able to re-establish its connection and data could no longer be handled by the service. Sustained exploitation of this vulnerability could lead to a denial-of-service condition affecting a large segment of the Internet community. With data injection, data may be spoofed. Spoofing involves sending false responses or signals.

Thus, the present invention provides an improved method, apparatus, and computer instructions for preventing denial of service attacks on TCP connections.

### SUMMARY OF THE INVENTION

The present invention provides an improved method, apparatus, and computer instructions for preventing denial of service attacks on persistent connections. A synchronize packet is received. In response to receiving the synchronize packet, a state of the persistent connection is identified. An action on the synchronize packet is deferred until a subsequent communication with a peer to the persistent connection.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is typical software architecture for a server-client system in accordance with a preferred embodiment of the present invention;

FIG. 5 is a TCP/IP and similar protocols in accordance with a preferred embodiment of the present invention; and

FIG. 6 is a flowchart of a process for the retrieval and saving of data packets in accordance with a preferred embodiment of the present invention;

FIG. 7 is a flowchart of a process for sending acknowledgements to senders in accordance with a preferred embodiment of the present invention.

### DETAILED DESCRIPTION OF THE PREFERRED EMBODIMENT

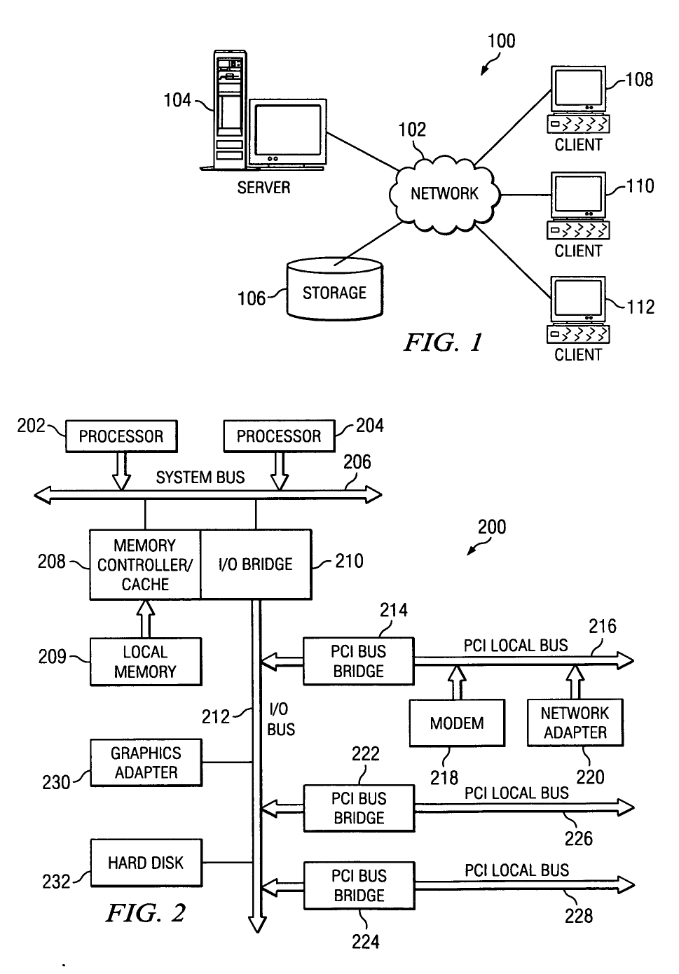

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

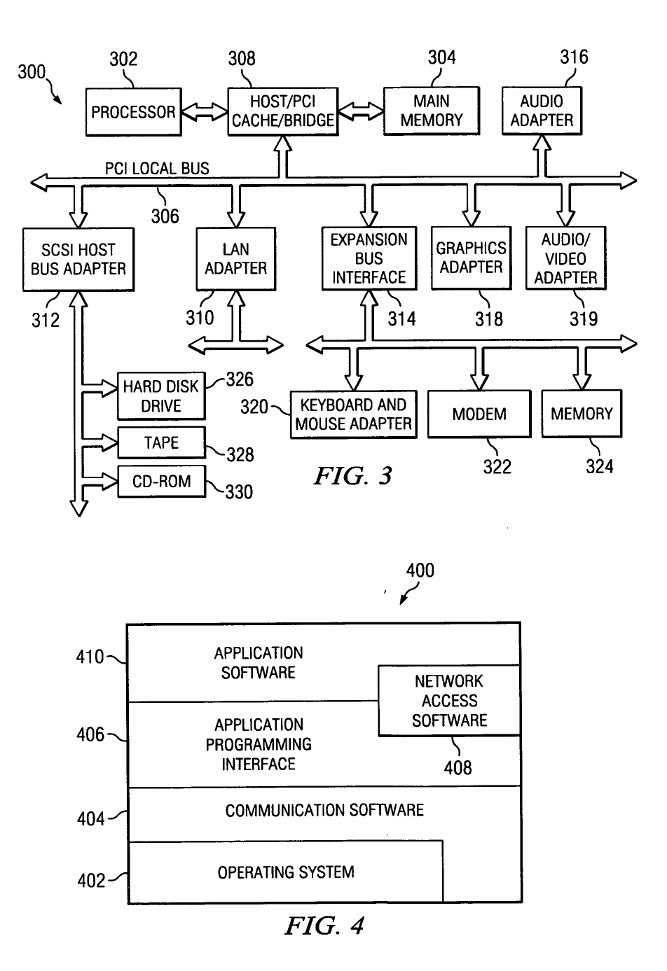

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for preventing a denial of service attack on persistent TCP connections. The mechanism of the present invention may be used to prevent attacks that attempt to reset a connection between two nodes. These attacks typically involve the sending of packets containing synchronize bits that are set. Packets or segments containing a synchronize bit also are referred to as a synchronize packet or segment. These packets are sent to either or both nodes in the connection in this type of attack.

The mechanism of the present invention defers taking action on this type of packet until the next communication event with a peer or node. This next event may be, for example, a pending acknowledgement or data packet that is to be sent. When no event is likely to occur at that time, a timer is used to force the sending of that acknowledgement when the timer expires if an acknowledgement triggering event does not occur before the timer expires. If a current data transfer is being performed, no extra actions are performed.

When the acknowledgement is finally sent, the other end will respond with a reset bit in a packet that also contains a sequence number exactly matching the expected sequence number. This situation resets the connection between the two nodes. On the other hand, if the other node has not sent the synchronize bit in the data, this other end simply drops the acknowledgement that is sent and the connections continues to remain active.

This mechanism also may be used to handle data injection problems. For this type of problem, a reaction or response occurs only when a data packet is an out of order data packet. When data is to be saved in a TCP reassembly queue, a check or determination is made as to whether the acknowledgement is less than what has been acknowledged. If the acknowledgement is less than what has been acknowledged so far, the data packet is dropped. In this case, if the data packet was from a real sender, the sender will retransmit the data packet at a later time with the proper acknowledgement number.

Tuning to FIG. 4, typical software architecture for a server-client system is depicted in accordance with a preferred embodiment of the present invention. A server and a client such as data processing system 200 in FIG. 2 and data processing system 300 in FIG. 3 are each architected with software architecture 400. At the lowest level, operating system 402 is utilized to provide high-level functionality to the user and to other software. Such an operating system typically includes a basic input output system (BIOS). Communication software 404 provides communications through an external port to a network such as the Internet via a physical communications link by either directly invoking operating system functionality or indirectly bypassing the operating system to access the hardware for communications over the network.

Application programming interface (API) 406 allows the user of the system, an individual, or a software routine, to invoke system capabilities using a standard consistent interface without concern for how the particular functionality is implemented. Network access software 408 represents any software available for allowing the system to access a network. This access may be to a network, such as a local area network (LAN), wide area network (WAN), or the Internet. With the Internet, this software may include programs, such as Web browsers.

Application software 410 represents any number of software applications designed to react to data through the communications port to provide the desired functionality the user seeks. Applications at this level may include those necessary to handle data, video, graphics, photos or text, which can be accessed by users of the Internet. The mechanism of the present invention may be implemented within communications software 404 in these examples.

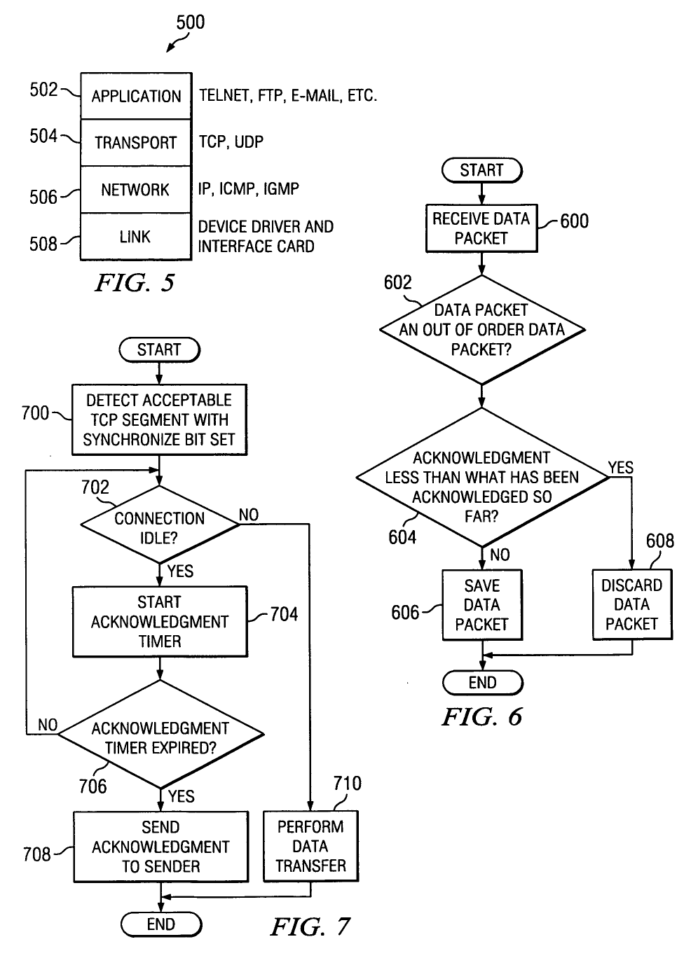

Tuning now to FIG. 5, a Transmission control protocol/Internet protocol (TCP/IP) and similar protocols is depicted in accordance with a preferred embodiment of the present invention. TCP/IP and similar protocols are utilized by communications architecture 500. In this example, communications architecture 500 is a 4-layer system. This architecture includes application layer 502, transport layer 504, network layer 506, and link layer 508. Each layer is responsible for handling various communications tasks. Link layer 508 also is referred to as the data-link layer or the network interface layer and normally includes the device driver in the operating system and the corresponding network interface card in the computer. This layer handles all the hardware details of physically interfacing with the network media being used, such as optical cables or Ethernet cables.

Network layer 506 also is referred to as the internet layer and handles the movement of packets of data around the network. For example, network layer 506 handles the routing of various packets of data that are transferred over the network. Network layer 506 in the TCP/IP suite is comprised of several protocols, including Internet protocol (IP), Internet control message protocol (ICMP), and Internet group management protocol (IGMP). Next, transport layer 504 provides an interface between network layer 506 and application layer 502 that facilitates the transfer of data between two host computers. Transport layer 504 is concerned with things such as, for example, dividing the data passed to it from the application into appropriately sized chunks for the network layer below, acknowledging received packets, and setting timeouts to make certain the other end acknowledges packets that are send. In the TCP/IP protocol suite, two distinctly different transport protocols are present, TCP and User datagram protocol (UDP). TCP provides reliability services to ensure that data is properly transmitted between two hosts, including dropout detection and retransmission services.

Conversely, UDP provides a much simpler service to the application layer by merely sending packets of data called datagrams from one host to the other, without providing any mechanism for guaranteeing that the data is properly transferred. When using UDP, the application layer must perform the reliability functionality.

Application layer 502 handles the details of the particular application. Many common TCP/IP applications are present for almost every implementation, including a Telnet for remote login; a file transfer protocol (FTP); a simple mail transfer protocol (SMTP) for electronic mail; and a simple network management protocol (SNMP).

The mechanism of the present invention may be more specifically implemented in transport layer 504 in these examples. The mechanism in this layer is used to handle the receipt of packets or segments with regard to TCP connections.

Turning to FIG. 6, a flowchart of a process for the retrieval and saving of data packets is depicted in accordance with a preferred embodiment of the present invention. The process illustrated in FIG. 6 may be implemented in a TCP stack, such as one found in transport layer 504 in FIG. 5. This process is used to handle attacks involving data injections.

The process begins by receiving a data packet (step 600). A determination is made as to whether the data packet is an out of order data packet (step 602). If the data packet is not an out of order data packet, a determination is made as to whether an acknowledgement is less than what has been acknowledged so far (step 604). If an acknowledgement that is less than what has been acknowledged so far is not present, the process saves the data packet (step 606), with the process terminating thereafter.

Turning back now to step 604, if an acknowledgement that is less than what has been acknowledged so far is present, the process discards the data packet (step 608) thus ending the process.

Turning to FIG. 7, a flowchart of a process for sending acknowledgements to senders is depicted in accordance with a preferred embodiment of the present invention. The process illustrated in FIG. 7 may be implemented in a TCP stack, such as one found in transport layer 504 in FIG. 5. The process in this figure is used to handle attacks that attempt to force the resetting of a connection.

The process begins by detecting an acceptable TCP segment with synchronize bit set (step 700). Next, a determination is made as to whether the connection is idle (step 702). If an idle connection is present, the acknowledgment timer is started (step 704). Then, a determination is then made as to whether the acknowledgement timer has expired (step 706). If the acknowledgement timer has expired, an acknowledgement is sent to the sender of the acceptable TCP segment (step 708) with the process terminating thereafter.

Turning back to step 702, if an idle connection is not present, a data transfer is performed (step 710) with the process terminating thereafter. This data transfer is performed without performing any additional actions. In this manner, the attacker is effectively ignored. Turning back now to step 706, if an expired acknowledgement timer in not present, the process returns to step 702 to determine whether the connection is idle.

Thus, the present invention provides an improved method, apparatus, and computer instructions for preventing a denial of service attack on a persistent connection. When a packet containing a synchronize bit is received, action on the packet is deferred based on the state of the persistent connection.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, the illustrative examples are directed towards a TCP connection. The mechanism of the present invention may be applied to other types of connections in which this type of attack may occur. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for preventing a denial of service attack on a persistent connection, the method comprising:
receiving a synchronize packet; and
responsive to receiving the synchronize packet, deferring an action on the synchronize packet until a subsequent communication with a peer to the persistent connection.

2. The method of claim 1, wherein the deferring step includes:
determining a state of the persistent connection;
responsive to the persistent connection being an idle connection, starting a timer; and
sending an acknowledgement packet to a source of the synchronize packet in response to an expiration of the timer, wherein only a single acknowledgement is sent for all synchronize packets sent by the source prior to the expiration of the timer.

3. The method of claim 1, wherein the deferring step includes:
determining a state of the persistent connection;
responsive to the persistent connection having a current data transaction, sending an acknowledgement packet to a source of the synchronize packet

4. The method of claim 1, wherein the subsequent communication is at least one of a pending acknowledgement for the peer and a transmission of data packet to the peer.

5. The method of claim 1, wherein the persistent connection is a transmission control protocol connection.

6. The method of claim 1, wherein the method is implemented in a transport layer.

7. A method in a data processing system for preventing a denial of service attack on a persistent connection, the method comprising:
responsive to receiving a packet for data injection, determining whether the packet is an out of order packet;
ignoring the packet if the packet is not an out of order packet;
responsive to the packet being an out of order packet, determining whether the acknowledgment is less than what has been previously acknowledged; and
if the acknowledgment is less than what has been previously acknowledge, dropping the out of data packet.

8. The method of claim 7, wherein the persistent connection is a transmission control protocol connection.

9. A data processing system for preventing a denial of service attack on a persistent connection, the data processing system comprising:
receiving means for receiving a synchronize packet; and
deferring means, responsive to receiving the synchronize packet, for deferring an action on the synchronize packet until a subsequent communication with a peer to the persistent connection.

10. The data processing system of claim 9, wherein the deferring means includes:
determining means for determining a state of the persistent connection;
starting means, responsive to the persistent connection being an idle connection, for starting a timer; and
sending means for sending an acknowledgement packet to a source of the synchronize packet in response to an expiration of the timer, wherein only a single acknowledgement is sent for all synchronize packets sent by the source prior to the expiration of the timer.

11. The data processing system of claim 9, wherein the deferring means includes:
determining means for determining a state of the persistent connection;
sending means, responsive to the persistent connection having a current data transaction, for sending an acknowledgement packet to a source of the synchronize packet

12. The data processing system of claim 9, wherein the subsequent communication is at least one of a pending acknowledgement for the peer and a transmission of data packet to the peer.

13. The data processing system of claim 9, wherein the persistent connection is a transmission control protocol connection.

14. The data processing system of claim 9, wherein the data processing system is implemented in a transport layer.

15. A data processing system for preventing a denial of service attack on a persistent connection, the data processing system comprising:
first determining means, responsive to receiving a packet for data injection, for determining whether the packet is an out of order packet;
ignoring means for ignoring the packet if the packet is not an out of order packet;
second determining means, responsive to the packet being an out of order packet, for determining whether the acknowledgment is less than what has been previously acknowledged; and
dropping means for dropping the out of data packet, if the acknowledgment is less than what has been previously acknowledge.

16. The data processing system of claim 15, wherein the persistent connection is a transmission control protocol connection.

17. A computer program product in a data processing system for preventing a denial of service attack on a persistent connection, the computer program product comprising:
first instructions for receiving a synchronize packet; and
second instructions, responsive to receiving the synchronize packet, for deferring an action on the synchronize packet until a subsequent communication with a peer to the persistent connection.

18. The computer program product of claim 17, wherein the second instructions includes:
first sub instructions for determining a state of the persistent connection;
second sub instructions, responsive to the persistent connection being an idle connection, for starting a timer; and
third sub instructions for sending an acknowledgement packet to a source of the synchronize packet in response to an expiration of the timer, wherein only a single acknowledgement is sent for all synchronize packets sent by the source prior to the expiration of the timer.

19. The computer program product of claim 17, wherein the second instructions includes:
first sub instructions for determining a state of the persistent connection;
second sub instructions, responsive to the persistent connection having a current data transaction, for sending an acknowledgement packet to a source of the synchronize packet

20. The computer program product of claim 17, wherein the subsequent communication is at least one of a pending acknowledgement for the peer and a transmission of data packet to the peer.

21. The computer program product of claim 17, wherein the persistent connection is a transmission control protocol connection.

22. The computer program product of claim 17, wherein the computer program product is implemented in a transport layer.

23. A computer program product in a data processing system for preventing a denial of service attack on a persistent connection, the computer program product comprising:
first instructions, responsive to receiving a packet for data injection, for determining whether the packet is an out of order packet;
second instructions for ignoring the packet if the packet is not an out of order packet;
third instructions, responsive to the packet being an out of order packet, for determining whether the acknowledgment is less than what has been previously acknowledged; and
fourth instructions for dropping the out of data packet, if the acknowledgment is less than what has been previously acknowledge.

24. The computer program product of claim 23, wherein the persistent connection is a transmission control protocol connection.
